(19) United States
(12) Patent Application Publication
(10) Pub. No.: US 2019/0207872 A1
(43) Pub. Date: Jul. 4, 2019

(54) A NETWORK ELEMENT AND A METHOD FOR CONTROLLING THE SAME

(71) Applicant: CORIANT OY, Espoo (FI)

(72) Inventor: Ville HALLIVUORI, Espoo (FI)

(21) Appl. No.: 16/326,383

(22) PCT Filed: Aug. 26, 2016
(86) PCT No.: PCT/FI2016/050585

§ 371 Date: Feb. 19, 2019

(51) Int. Cl. H04L 12/937; H04L 12/841; H04L 12/933; H04L 12/911; H04L 12/715; H04L 12/26

(52) U.S. Cl. CPC H04L 49/255; H04L 47/283; H04L 43/0852; H04L 47/825; H04L 45/64; H04L 49/105

(57) ABSTRACT

A network element (101), for example a router, comprises a processing system (103) for running a protocol in accordance of which the network element is communicating with another network element. The protocol comprises monitoring whether the protocol receives, within a protocol message -specific time-window, a protocol message transmitted by the other network element. The time-window may represent for example a timeout period. The processing system measures waiting times of messages received at the network element, where each measured waiting time is at least a part of time a corresponding received message waits for a service provided by the processing system. The processing system determines the length of the time-window based on the measured waiting times. Therefore, the waiting time of the received protocol message can be compensated for and thereby wrong determinations about the reachability of the other network element can be avoided or at least reduced.

### FIELD OF THE DISCLOSURE

The disclosure relates to a method for controlling a network element of a data transfer network so that wrong determinations about reachability of other network elements can be avoided or at least reduced. Furthermore, the disclosure relates to a computer program for controlling a network element. Furthermore, the disclosure relates to a network element, e.g. a router, for a data transfer network.

### BACKGROUND

Many protocols used in data transfer networks comprise status monitoring which is based on protocol messages transferred between network elements running the protocol. When a first network element receives the protocol messages properly from a second network element, the first network element knows that the second network element is reachable, i.e. the second network element is not in a fault state or otherwise disabled and there is a working data transfer connection from the second network element. In conjunction with some protocols, properly received protocol messages express not only that the data transfer connection from the second network element is working but also that a data transfer connection to the second network element is working. Each network element can be for example an Internet Protocol “IP” router, a MultiProtocol Label Switching “MPLS” switch, a packet optical switch, an Ethernet switch, an Asynchronous Transfer Mode “ATM” switch, and/or a software-defined networking “SDN” controlled network element. Each protocol message can be for example a data frame such as an IP-packet, an Ethernet frame, or a data cell such as an ATM-cell.

In conjunction with some protocols, the above-mentioned status monitoring is based on query messages sent from a first network element to a second network element and on reply messages sent, in response to the reception of the query messages, from the second network element to the first network element. The first network element is configured to monitor whether a reply message arrives from the second network element within a pre-determined time after sending the respective query message. If the reply message does not arrive within the predetermined time, the first network element may deem the second network element to be unreachable i.e. the second network element is in a fault state or otherwise disabled and/or data transfer connections to and from the second network element is/are down. Typically, the monitoring is implemented with timers. In conjunction with some protocols, the status monitoring is based on periodically transmitted protocol messages, e.g. “hello”-messages. In this exemplifying case, a first network element monitors the reception of protocol messages which are periodically transmitted by a second network element. The first network element can be configured to deem the second network element to be unreachable if a predetermined time has elapsed after the reception of the most recently received protocol message.

An inherent challenge related to protocols of the kind described above is that, in many network elements, it is not possible to handle all messages arriving at the network element immediately after the reception of each message but, in practice, the messages have to be placed in a queuing system to wait for a service provided by a processing system of the network element. In a case where a first network element is heavily loaded so that it receives different messages at a high rate, it is possible that a time reserved for receiving a protocol message from a second network element elapses when the received protocol message is queuing for service in the first network element. In other words, the protocol message has been properly received within the reserved time but the first network element is so busy that it did not recognize that one of received messages is the above-mentioned protocol message. Thus, the first network element may wrongly deem the second network element to be unreachable even if the protocol message has properly arrived at the first network element.

The above-described problem has been alleviated with sophisticated queuing systems which have different priorities and/or weights for different types of received messages. An inherent challenge related to this approach is that the received messages may comprise also other messages which have to be given a high priority in a queuing system. For example, messages representing real-time “RT” data traffic have to be given a high priority since the transfer delay of the real-time data traffic has to be minimized. Furthermore, the above-described problem has been alleviated with multi-threaded implementations where received messages are serviced not only sequentially but also in parallel. This approach, however, increases the complexity of a network element.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for controlling a network element of a data transfer network. The network element runs at least one protocol in accordance of which the network element is communicating with at least one other network element of the data transfer network, and the protocol comprises monitoring whether functionality related to the protocol and run by a processing system of the network element receives, within a protocol message—specific time-window, a protocol message transmitted by the other network element. The wording “functionality related to the protocol” is used because in some implementations a protocol message can have been received by e.g. a Central Processing Unit “CPU” but the monitoring related to the protocol message-specific time-window can be done only when the CPU starts to process the received protocol message in accordance with the functionality related to the protocol, e.g. the CPU reads a sufficient amount of data from the received protocol message. The protocol message-specific time-window can be, for example but not necessarily, a timeout period so that the network element updates status data indicative of reachability of the other network element if the processing system does not receive the protocol message within the timeout period. The status data can be updated for example by setting the status data to indicate that the other network element is unreachable. For another example, the status data can be a counter value for counting events when a protocol message is not received within a respective time-window related to the protocol message under consideration. In this exemplifying case, the other network element can be deemed to be unreachable for example if the status data is changed by a pre-determined amount within a predetermined time period.

A method according the invention comprises:
measuring waiting times of messages received at the network element from the data transfer network, each measured waiting time being at least a part of time a corresponding one of the received messages is waiting for a service provided by the processing system, and
determining, at least partly based on the measured waiting times, the length of the protocol message-specific time-window so as to compensate for the waiting time of the received protocol message when monitoring the reception of the protocol message.

As the length of the protocol message-specific time-window is determined at least partly based on the measured waiting times, the waiting time of each received protocol message can be compensated for and thereby wrong determinations about the reachability of the other network element can be avoided or at least reduced. On the other hand, the measured waiting times provide information with the aid of which unnecessarily long extensions of the protocol message-specific time-windows can be avoided. Too long extensions might disturb the operation of the protocol.

The above-described method according to the invention can be combined with other methods for solving the above-described technical problem. The other methods may comprise for example use of sophisticated queuing systems and/or multithreaded implementations mentioned earlier in this document.

In accordance with the invention, there is provided also a new network element that can be for example an Internet Protocol “IP” router, a multiprotocol label switching “MPLS” switch, a packet optical switch, an Ethernet switch, an asynchronous transfer mode “ATM” switch, and/or a software-defined networking “SDN” controlled network element.

A network element according to the invention comprises:
a data transfer interface for receiving data from a data transfer network and for transmitting data to the data transfer network, and
a processing system for running at least one protocol in accordance of which the network element is communicating with at least one other network element, the protocol comprising monitoring whether functionality related to the protocol and run by the processing system receives, within a protocol message-specific time-window, a protocol message transmitted by the other network element.

The processing system is configured to:
measure waiting times of messages received from the data transfer network, each measured waiting time being at least a part of time a corresponding one of the received messages is waiting for a service provided by the processing system, and
determine, at least partly based on the measured waiting times, the length of the protocol message-specific time-window so as to compensate for the waiting time of the received protocol message when monitoring the reception of the protocol message.

In accordance with the invention, there is provided also a new computer program for controlling a network element that comprises a processing system for running at least one protocol of the kind mentioned above.

A computer program according to the invention comprises computer executable instructions for controlling a programmable processor of the network element to:
measure waiting times of messages received at the network element from a data transfer network, each measured waiting time being at least a part of time a corresponding one of the received messages is waiting for a service provided by the processing system of the network element, and
determine, at least partly based on the measured waiting times, the length of a protocol message-specific time-window so as to compensate for the waiting time of a received protocol message when monitoring whether the protocol message is received, within the protocol message-specific time-window, by functionality related to the protocol and run by the processing system of the network element.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below with reference to the accompanying drawings, in which:

FIG. 1 shows a schematic illustration of a network element according to an exemplifying and non-limiting embodiment of the invention, and

FIG. 2 shows a flowchart of a method according to an exemplifying and nonlimiting embodiment of the invention for controlling a network element of a data transfer network.

### DESCRIPTION OF EXEMPLIFYING AND NON-LIMITING EMBODIMENTS

The specific examples provided in the description below should not be construed as limiting the scope and/or the applicability of the accompanied claims. Lists and groups of examples provided in the description below are not exhaustive unless otherwise explicitly stated.

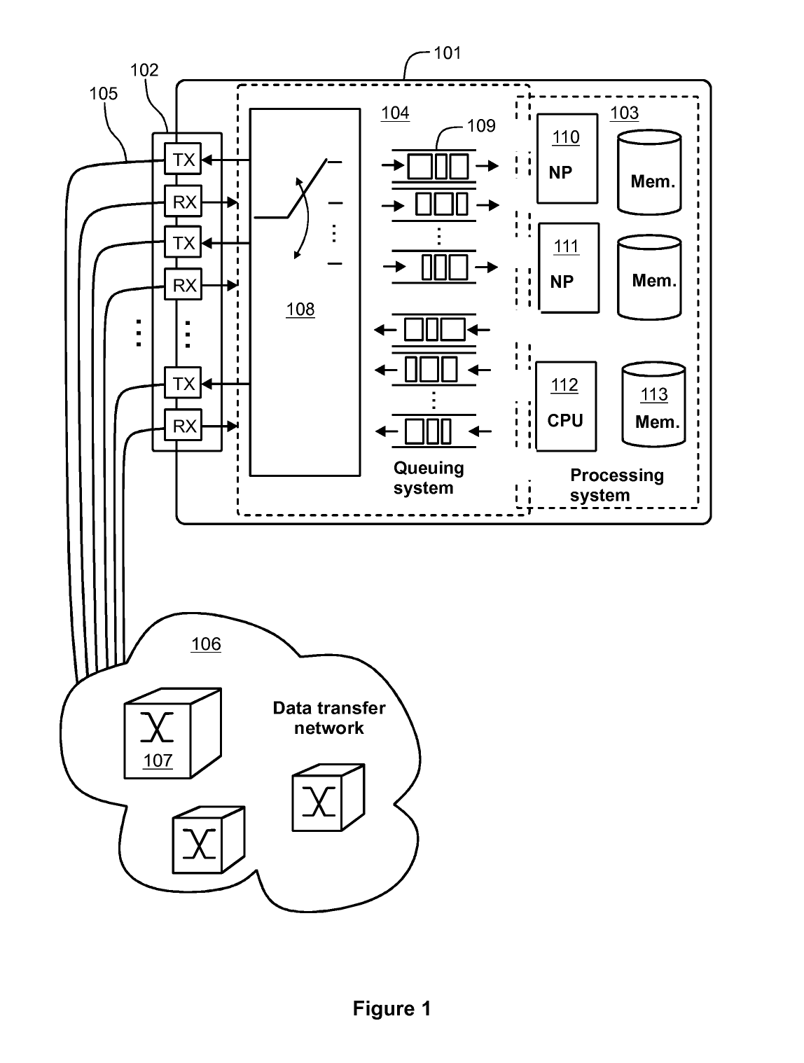

FIG. 1 shows a schematic illustration of a network element 101 according to an exemplifying and non-limiting embodiment of the invention. The network element 101 can be for example an Internet Protocol “IP” router, a multiprotocol label switching “MPLS” switch, a packet optical switch, an Ethernet switch, an asynchronous transfer mode “ATM” switch, and/or a software-defined networking “SDN” controlled network element. The network element 101 comprises a data transfer interface 102 for receiving data from a data transfer network 106 and for transmitting data to the data transfer network. The data transfer interface 102 comprises egress ports “TX” and ingress ports “RX” which are connected with data transfer links to the data transfer network 106. In FIG. 1, one of the data transfer links is denoted with a reference 105. The network element 101 comprises a processing system 103. In the exemplifying network element 101 illustrated in FIG. 1, the processing system 103 comprises network processors “NP” two of which are denoted with references 110 and 111, a central processing unit “CPU” 112, and memory 113. The network element 101 further comprises a queuing system 104 where messages received at a network element 101 wait for services provided by the processing system 103 and where messages to be sent wait for transmission by the data transfer interface 102. Each message may comprise one or more Internet Protocol “IP” packets, Ethernet frames, Asynchronous Transfer Mode “ATM” cells, and/or one or more other data entities. It is worth noting that FIG. 1 is merely a high-level functional illustration which does not illustrate the physical implementation of the network element 101. For example, the processing system 103 can be implemented in a distributed way so that the network processors and parts of the memory 113 are located in line interface units which are communicatively connected to a control unit comprising the CPU 112 and a part of the memory 113. Correspondingly, the queuing system 104 can be implemented in a distributed way so that parts of the queuing system 104 are located in the line interface units whereas a part of the queuing system 104 can be implemented in the control unit comprising the CPU 112. In FIG. 1, one of queues maintained by the queuing system 104 for received messages is denoted with a reference 109. Furthermore, the network element 101 may comprise a switch fabric unit which may comprise one or more processors of the processing system 103 and/or a part of the queuing system 104 and/or a part of the memory 113. In many cases, the queuing system 104 has a first logical section where data is queuing from network processors to the CPU 112 and a second logical section where data is under control of the CPU and queuing for services provided by processes run in the CPU. In many cases, the second logical section is a more challenging bottle-neck than the first section.

The processing system 103 is configured to run at least one protocol in accordance of which the network element 101 is communicating with one or more other network elements of the data transfer network 106. In FIG. 1, one of the other network elements is denoted with a reference 107. The protocol comprises monitoring whether the functionality related to the protocol and run by the processing system 103 receives, within a protocol message-specific time-window, a protocol message transmitted by the network element 107. The protocol message-specific time-window can be, for example but not necessarily, a timeout period related to the protocol message so that the processing system 103 updates status data indicative of the reachability of the network element 107 if the functionality related to the protocol and run by the processing system 103 does not receive the protocol message within the timeout period. The status data can be updated for example by setting the status data to indicate that the network element 107 is not reachable. For another example, the status data can be a counter value for counting events when a protocol message is not received within a respective time-window.

In this exemplifying case, the network element 107 can be deemed to be unreachable for example if the status data is changed by a pre-determined amount within a pre-determined time period.

Depending on the protocol under consideration, there are different ways to monitors the protocol messages. In an exemplifying case, the processing system 103 is configured to control the data transfer interface 102 to transmit a query message to the network element 107 and wait for a protocol message that represents a response to the query message. The processing system 103 is configured to update the status data indicative of the reachability of the network element 107 in response to a situation in which time elapsed after transmitting the query message and without receiving the protocol message exceeds the length of the protocol message-specific time-window. In another exemplifying case, the network element 107 is configured to periodically send protocol messages to the network element 101 so as to indicate that the network element 107 is active and the data transfer connection from the network element 107 to the network element 101 is working. In this exemplifying case, the processing system 103 can be configured to update the status data indicative of the reachability of the network element 107 in response to a situation in which time elapsed after receiving the most recent protocol message exceeds the length of the protocol message-specific time-window. The protocol under consideration can be for example the Intermediate System to Intermediate System “IS-IS” protocol or the Open Shortest Path First “OSPF” protocol. In conjunction with the OSPF, each protocol message can be an OSPF Hellolnterval and each protocol message-specific time-window can be an OSPF RouterDeadInterval.

The processing system 103 is configured to measure waiting times of messages received from the data transfer network 106. Each measured waiting time is at least a part of time the corresponding received message is waiting for a service provided by the processing system 103. Depending on the implementation of the network element, the waiting times of the received messages can be measured in different ways. In an exemplifying case, the measurement of each waiting time begins when a message under consideration is received at the data transfer interface 102 and ends when functionality related to the protocol and run by the processing system 103 begins to process the message. In another exemplifying case, the measurement of each waiting time begins when a message under consideration is placed in a given queue maintained by the queuing system 104 and ends when the message is removed from the queue for further actions. In this exemplifying case, the measured waiting time is only a part of the total time the message under consideration is waiting for a service. If needed, the total time can be estimated with the aid of the measured waiting time and a suitable mathematical rule. The estimate of the total time can be for example: the measured waiting time+α₁×the measured waiting time+α₂, where α₁ is a factor for modelling a time component caused by portions of the queueing system 104 which behave substantially in the same way as the above-mentioned queue and thereby the above-mentioned time component is substantially proportional to the measured waiting time, and α₂ models a time component caused by portions of the queueing system 104 which have a substantially constant processing delay. In an exemplifying case, the messages whose waiting times are measured comprise protocol messages only. Thus, the messages whose waiting times are measured do not comprise other received messages such as messages carrying payload data. In this exemplifying case, the network element comprises a preliminary classifier 108 for separating the received protocol messages from the other received messages. In another exemplifying case, the messages whose waiting times are measured comprise not only the protocol messages but also the other received messages. This exemplifying approach is applicable in network elements where it is not possible to distinguish the protocol messages from the other received messages prior to the messages are processed, e.g. inspected, by the processing system 103.

The processing system 103 is configured to determine the lengths of protocol message-specific time-windows of the kind mentioned above at least partly based on the measured waiting times. As the length of each protocol message-specific time-window is determined at least partly based on the measured waiting times, the waiting time of each received protocol message can be compensated for and thereby wrong determinations about the reachability of the network element 107 can be avoided or at least reduced. The processing system 103 can be configured to apply a pre-determined mathematical rule on the measured waiting times so as to determine the lengths of the protocol message-specific time-windows.

In a network element according to an exemplifying and non-limiting embodiment of the invention, the processing system 103 is configured to compute a low-pass filtered value of the measured waiting times and to set the lengths of the protocol message-specific time-windows at least partly based on the low-pass filtered value of the measured waiting times. The lengths of the protocol message-specific time-windows can be for example: the low-pass filtered value of the measured waiting times+A₁×the low-pass filtered value of the measured waiting times+A₂, where A₁ and A₂ are parameters given as input data to the processing system 103. The parameter A₂ can be for example the original value of the lengths of the protocol message-specific time-windows, e.g. an original timeout period, which has been set when configuring the network element 101 to support the protocol under consideration. The low-pass filtered value can be computed with e.g. a finite impulse response “FIR” digital filter or an infinite impulse response “IIR” digital filter. A FIR low-pass filter can be e.g. a filter which computes an arithmetic average of two or more most recently measured waiting times. An IIR low-pass filter can be for example a 1^{st} order filter having a pole at zero frequency.

In a network element according to an exemplifying and non-limiting embodiment of the invention, the processing system 103 is configured to select the maximum from among a pre-determined number of most recently measured waiting times and to set the lengths of the protocol message-specific time-windows at least partly based on the selected maximum. The lengths of the protocol message-specific time-windows can be for example: the selected maximum+B₁×selected maximum+B₂, where B₁ and B₂ are parameters given as input data to the processing system 103.

In a network element according to an exemplifying and non-limiting embodiment of the invention, the processing system 103 is configured to select the maximum from among waiting times measured during a moving measurement time-window and to set the lengths of the protocol message-specific time-windows at least partly based on the selected maximum. The lengths of the protocol message-specific time-windows can be for example: the selected maximum+C₁×selected maximum+C₂, where C₁ and C₂ are parameters given as input data to the processing system 103.

Each processor of the processing system 103, such as the network processors 110 and 111 and the CPU 112, can be implemented with one or more processor circuits each of which can be a programmable processor circuit provided with appropriate software, a dedicated hardware processor such as for example an application specific integrated circuit “ASIC”, or a configurable hardware processor such as for example a field programmable gate array “FPGA”. The memory 113 can be implemented with one or more memory circuits each of which can be a random access memory “RAM” or a content access memory “CAM”. The queuing system 104 can be implemented with one or more memory circuits for storing data and a control system for scheduling the operation of the queues. The control system can be implemented with processors of the processing system 103.

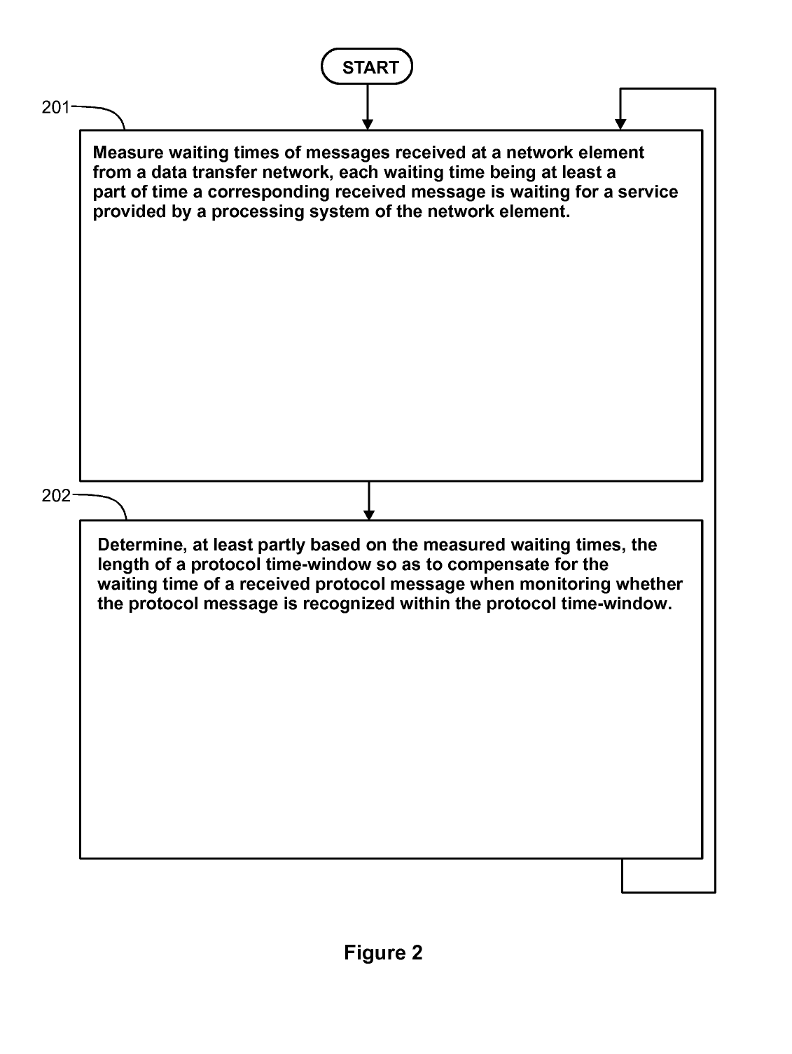

FIG. 2 shows a flowchart of a method according to an exemplifying and non-limiting embodiment of the invention for controlling a network element of a data transfer network. The network element runs at least one protocol in accordance of which the network element is communicating with at least one other network element of the data transfer network, and the protocol comprises monitoring whether functionality related to the protocol and run by a processing system of the network element receives, within a protocol message-specific time-window, a protocol message transmitted by the other network element.

The method comprises the following actions:
action 201: measuring waiting times of messages received at the network element from the data transfer network, each measured waiting time being at least a part of time a corresponding one of the received messages is waiting for a service provided by the processing system of the network element, and
action 202: determining, at least partly based on the measured waiting times, the length of the protocol message-specific time-window so as to compensate for the waiting time of the received protocol message when monitoring the reception of the protocol message.

A method according to an exemplifying and non-limiting embodiment of the invention comprises applying a pre-determined mathematical rule on the measured waiting times so as to determine the length of the protocol message-specific time-window.

A method according to an exemplifying and non-limiting embodiment of the invention comprises computing a low-pass filtered value of the measured waiting times and setting the length of the protocol message-specific time-window at least partly based on the low-pass filtered value of the measured waiting times. The low pass filtered value can be computed for example with a finite impulse response “FIR” digital filter or with an infinite impulse response “IIR” digital filter.

A method according to an exemplifying and non-limiting embodiment of the invention comprises:
selecting the maximum from among the waiting times measured for a pre-determined number of the most recently received ones of the messages, and
setting the length of the protocol message-specific time-window at least partly based on the selected maximum.

A method according to an exemplifying and non-limiting embodiment of the invention comprises:
selecting the maximum from among the waiting times measured for ones of the messages received during a moving measurement time-window, and
setting the length of the protocol message-specific time-window at least partly based on the selected maximum.

A method according to an exemplifying and non-limiting embodiment of the invention comprises:
controlling the network element to transmit a query message to the other network element,
waiting for the protocol message representing a response to the query message, and
updating status data indicative of reachability of the other network element in response to a situation in which time elapsed after transmitting the query message and without receiving the protocol message exceeds the length of the protocol message-specific time-window.

A method according to an exemplifying and non-limiting embodiment of the invention comprises updating status data indicative of reachability of the other network element in response to a situation in which time elapsed without receiving the protocol message and after receiving a previous protocol message exceeds the length of the protocol message-specific time-window.

In a method according to an exemplifying and non-limiting embodiment of the invention, the network element is at least one of the following: an Internet Protocol

IP router, a MultiProtocol Label Switching MPLS switch, a packet optical switch, an Ethernet switch, an Asynchronous Transfer Mode ATM switch, a software-defined networking SDN controlled network element.

A computer program according to an exemplifying and non-limiting embodiment of the invention comprises computer executable instructions for controlling a programmable processing system to carry out actions related to a method according to any of the above-described exemplifying embodiments of the invention.

A computer program according to an exemplifying and non-limiting embodiment of the invention comprises software modules for controlling a network element of a data transfer network. The network element is configured to run at least one protocol in accordance of which the network element is communicating with at least one other network element of the data transfer network, and the protocol comprises monitoring whether functionality related to the protocol and run by a processing system of the network element receives, within a protocol message-specific time-window, a protocol message transmitted by the other network element. The software modules comprise computer executable instructions for controlling a programmable processor of the network element to:
measure waiting times of messages received at the network element from the data transfer network, each measured waiting time being at least a part of time a corresponding one of the received messages is waiting for a service provided by the processing system of the network element, and
determine, at least partly based on the measured waiting times, the length of the protocol message-specific time-window so as to compensate for the waiting time of the received protocol message when monitoring the reception of the protocol message.

The above-mentioned software modules can be e.g. subroutines or functions implemented with a suitable programming language and with a compiler suitable for the programming language and for the programmable processor under consideration. It is worth noting that also a source code corresponding to a suitable programming language represents the computer executable software modules because the source code contains information needed for controlling the programmable processor to carry out the above-presented actions and compiling changes only the format of the information. Furthermore, it is also possible that the programmable processor is provided with an interpreter so that a source code implemented with a suitable programming language does not need to be compiled prior to running.

A computer program product according to an exemplifying and non-limiting embodiment of the invention comprises a computer readable medium, e.g. a compact disc “CD”, encoded with a computer program according to an exemplifying embodiment of invention.

A signal according to an exemplifying and non-limiting embodiment of the invention is encoded to carry information defining a computer program according to an exemplifying embodiment of invention.

The specific examples provided in the description given above should not be construed as limiting the scope and/or the applicability of the appended claims. Lists and groups of examples provided in the description given above are not exhaustive unless otherwise explicitly stated.

1. A network element for a data transfer network, the network element comprising:
a data transfer interface for receiving data from the data transfer network and for transmitting data to the data transfer network, and
a processing system for running at least one protocol in accordance of which the network element is communicating with at least one other network element, the protocol comprising monitoring whether functionality related to the protocol and run by the processing system receives, within a protocol message-specific time-window, a protocol message transmitted by the other network element,
wherein the processing system is configured to:
measure waiting times of messages received from the data transfer network, each measured waiting time being at least a part of time a corresponding one of the received messages is waiting for a service provided by the processing system, and
determine, at least partly based on the measured waiting times, a length of the protocol message-specific time-window so as to compensate for the waiting time of the received protocol message when monitoring the reception of the protocol message.

2. A network element according to claim 1, wherein the processing system is configured to apply a pre-determined mathematical rule on the measured waiting times so as to determine the length of the protocol message-specific time-window.

3. A network element according to claim 2, wherein the processing system is configured to compute a low-pass filtered value of the measured waiting times and set the length of the protocol message-specific time-window at least partly based on the low pass filtered value of the measured waiting times.

4. A network element according to claim 3, wherein the processing system is configured to compute the low-pass filtered value with one of the following: a finite impulse response digital filter, an infinite impulse response digital filter.

5. A network element according to claim 2, wherein the processing system is configured to:
select a maximum from among the waiting times measured for a pre-determined number of most recently received ones of the messages, and
set the length of the protocol message-specific time-window at least partly based on the selected maximum.

6. A network element according to claim 2, wherein the processing system is configured to:
select a maximum from among the waiting times measured for ones of the messages received during a moving measurement time-window, and
set the length of the protocol message-specific time-window at least partly based on the selected maximum.

7. A network element according to claim 1, wherein the processing system is configured to:
control the data transfer interface to transmit a query message to the other network element,
wait for the protocol message representing a response to the query message, and
update status data indicative of reachability of the other network element in response to a situation in which time elapsed after transmitting the query message and without receiving the protocol message exceeds the length of the protocol message-specific time-window.

8. A network element according to claim 1, wherein the processing system is configured to update status data indicative of reachability of the other network element in response to a situation in which time elapsed without receiving the protocol message and after receiving a previous protocol message exceeds the length of the protocol message-specific time-window.

9. A network element according to claim 1, wherein the network element is at least one of the following: an Internet Protocol IP router, a MultiProtocol Label Switching MPLS switch, a packet optical switch, an Ethernet switch, an Asynchronous Transfer Mode ATM switch, a software-defined networking SDN controlled network element.

10. A method for controlling a network element of a data transfer network, the network element running at least one protocol in accordance of which the network element is communicating with at least one other network element of the data transfer network and the protocol comprising monitoring whether functionality related to the protocol and run by a processing system of the network element receives, within a protocol message-specific time-window, a protocol message transmitted by the other network element, the method comprising:
measuring waiting times of messages received at the network element from the data transfer network, each measured waiting time being at least a part of time a corresponding one of the received messages is waiting for a service provided by the processing system, and
determining, at least partly based on the measured waiting times, a length of the protocol message-specific time-window so as to compensate for the waiting time of the received protocol message when monitoring the reception of the protocol message.

11. A method according to claim 10, wherein the method comprises applying a pre-determined mathematical rule on the measured waiting times so as to determine the length of the protocol message-specific time-window.

12. A method according to claim 11, wherein the method comprises computing a low-pass filtered value of the measured waiting times and setting the length of the protocol message-specific time-window at least partly based on the low-pass filtered value of the measured waiting times.

13. A method according to claim 12, wherein the low pass filtered value is computed with one of the following: a finite impulse response digital filter, an infinite impulse response digital filter.

14. A method according to claim 11, wherein the method comprises:
selecting a maximum from among the waiting times measured for a pre-determined number of most recently received ones of the messages, and
setting the length of the protocol message-specific time-window at least partly based on the selected maximum.

15. A method according to claim 11, wherein the method comprises:
selecting a maximum from among the waiting times measured for ones of the messages received during a moving measurement time-window, and
setting the length of the protocol message-specific time-window at least partly based on the selected maximum.

16. A method according to claims 10, wherein the method comprises:
controlling the network element to transmit a query message to the other network element,
waiting for the protocol message representing a response to the query message, and
updating status data indicative of reachability of the other network element in response to a situation in which time elapsed after transmitting the query message and without receiving the protocol message exceeds the length of the protocol message-specific time-window.

17. A method according to claim 10, wherein the method comprises updating status data indicative of reachability of the other network element in response to a situation in which time elapsed without receiving the protocol message and after receiving a previous protocol message exceeds the length of the protocol message-specific time-window.

18. A method according to claim 10, wherein the network element is at least one of the following:
an Internet Protocol IP router, a MultiProtocol Label Switching MPLS switch, a packet optical switch, an Ethernet switch, an Asynchronous Transfer Mode ATM switch, a software-defined networking SDN controlled network element.

19. A non-transitory computer readable medium encoded with a computer program for controlling a network element of a data transfer network, the network element being configured to run at least one protocol in accordance of which the network element is communicating with at least one other network element of the data transfer network and the protocol comprising monitoring whether functionality related to the protocol and run by a processing system of the network element receives, within a protocol message-specific time-window, a protocol message transmitted by the other network element, the computer program comprising computer executable instructions for controlling a programmable processor of the processing system to:
measure waiting times of messages received at the network element from the data transfer network, each measured waiting time being at least a part of time a corresponding one of the received messages is waiting for a service provided by the processing system, and
determine, at least partly based on the measured waiting times, a length of the protocol message-specific time-window so as to compensate for the waiting time of the received protocol message when monitoring the reception of the protocol message.

20. (canceled)

21. A network element according to claim 2, wherein the processing system is configured to:
control the data transfer interface to transmit a query message to the other network element,
wait for the protocol message representing a response to the query message, and
update status data indicative of reachability of the other network element in response to a situation in which time elapsed after transmitting the query message and without receiving the protocol message exceeds the length of the protocol message-specific time-window.
